(19) United States
(12) Patent Application Publication
(10) Pub. No.: US 2024/0317901 A1
(43) Pub. Date: Sep. 26, 2024

(54) UTILIZATION OF 1-HEXENE IN MULTI-STAGE POLYOLEFIN PRODUCTION

(71) Applicant: BOREALIS AG, Vienna (AT)

(72) Inventors: Victor SUMERIN, Porvoo (FI); Vasileios KANELLOPOULOS, Linz (AT); Jani AHO, Porvoo (FI); Matthias HOFF, Linz (AT); Joana Elvira KETTNER, Linz (AT); Irfan SAEED, Porvoo (FI); Kalle KALLIO, Porvoo (FI); Apostolos KRALLIS, Porvoo (FI)

(21) Appl. No.: 18/572,410

(22) PCT Filed: Jun. 23, 2022
(86) PCT No.: PCT/EP2022/067184

§ 371 Date: Dec. 20, 2023

(30) Foreign Application Priority Data
Jun. 24, 2021 (EP) 21181475.1

(51) Int. Cl. C08F 2/00; C08F 2/34; C08F 4/659; C08F 210/16

(52) U.S. Cl. CPC C08F 2/001; C08F 2/34; C08F 4/65912; C08F 210/16; C08F 2400/02

(57) ABSTRACT

The disclosure relates to a process for polymerising olefins in multi stage polymerisation process configuration, the process comprising a) polymerising in a first polymerisation step ethylene, optionally in the presence of at least one other alpha olefin comonomer, in the presence of a polymerisation catalyst so as to form a first polymer component (A); and b) polymerising in a second polymerisation step in gas phase a predetermined monomer mixture comprising ethylene and 1-hexene, optionally in the presence of at least one other alpha olefin comonomer, in the presence of the first polymer component (A) of step a), so as to form a second polymer component (B), wherein the multimodal polyethylene polymer produced by the present process comprises 1-hexene comonomer and at least one further C4-10-comonomer, and wherein the predetermined monomer mixture comprising ethylene and 1-hexene is fed into the second polymerisation step from the beginning of its start up. The disclosure further relates to use of 1-hexene in a gas phase olefin polymerisation step for improving performance of single-site polymerisation catalyst in multi-stage olefin copolymerisation process. The disclosure still further relates to a method for improving performance of single-site polymerisation catalyst in a multi-stage olefin polymerisation comprising feeding a predetermined monomer mixture comprising ethylene and 1-hexene into the gas phase polymerisation step from the beginning of its start up.

### FIELD OF THE DISCLOSURE

The present disclosure relates to copolymerisation of olefins, and more particularly to a multi-stage polyolefin production process for producing ethylene/1-butene/1-hexene terpolymers. The present disclosure further concerns the use of 1-hexene in a gas phase polymerisation step for improving the performance of single-site catalyst in multi-stage olefin copolymerisation process.

### BACKGROUND OF THE DISCLOSURE

Multi-stage polyolefin production processes (e.g. Borstar PE, PP and Spheripol PP) consist of multi-stage reactor configuration to give the multi-modal capability for achieving easy to process resins with desired mechanical properties. In such processes, a combination of slurry loop reactors in series followed by a gas phase reactor is employed to produce a full range of polyolefin grades.

One of the key features in multi-stage olefin polymerisation processes is to assure proper catalyst performance in all stages of the multi-stage polymerisation process, and more particularly, appropriate selection of the gas-phase reactor operating conditions that would result in smooth operability in GPR. With single-site catalysts that have superior comonomer incorporation capabilities as compared to the 1^{st} generation ones this may be challenging. Presence of small size particles (also known as Stocke's particles: particles that in gas-solids fluidization environment the buoyancy forces are higher than the gravitational forces) which have the tendency to be entrained by the fluidization gas may cause issues related to reactor fouling (polymer coating on the reactor wall), sheeting and chunking as well as fouling of the circulation gas compressor and the heat exchanger units. In this context, optimizing the catalyst performance in terms of eliminating the population of small-size particles in the GPR is of paramount importance and represents a key aspect to successful implementation of the catalyst in a multi-stage ethylene copolymerisation process.

### BRIEF DESCRIPTION OF THE DISCLOSURE

An object of the present disclosure is to provide a process for polymerising olefins in multi stage polymerisation process configuration so as to overcome the above disadvantages.

The object of the disclosure is achieved by a process, which is characterized by what is stated in the independent claims. The preferred embodiments of the disclosure are disclosed in the dependent claims.

The disclosure is based on the idea of injecting 1-hexene since the gas phase start up in to the gas phase reactor. This assures proper catalyst performance in all stages of the multi-stage polymerisation process, and more particularly, appropriate selection of the gas phase reactor operating conditions that would result in smooth operability in GPR.

More particularly, the present disclosure establishes a start-up policy for the gas phase reactor in terms of properly injecting the comonomer aiming to improve the performance of the catalyst which in turn results in enhanced reactor operability and process performance, while demanding products (e.g. low density low MFR) can be produced.

### DETAILED DESCRIPTION OF THE DISCLOSURE

The disclosure relates to a process for polymerising olefins in multi stage polymerisation process configuration, the process comprising
a) polymerising in a first polymerisation step ethylene, optionally in the presence of at least one other alpha olefin comonomer, in the presence of a polymerisation catalyst so as to form a first polymer component (A); and
b) polymerising in a second polymerisation step in gas phase a predetermined monomer mixture comprising ethylene and 1-hexene, optionally in the presence of at least one other alpha olefin comonomer, in the presence of the first polymer component (A) of step a), so as to form a second polymer component (B),
wherein the multimodal polyethylene polymer produced by the present process comprises 1-hexene comonomer and at least one further C4-10-comonomer, and
wherein the predetermined monomer mixture comprising ethylene and 1-hexene is fed into the second polymerisation step from the beginning of its start up.

Introduction of a predetermined monomer mixture comprising ethylene and 1-hexene to a gas-phase reactor in the second polymerisation step since the beginning of the gas-phase process operation decreases the population of small size particles (less than 80 μm), thus improving the catalyst performance during gas phase reactor operation.

Assuring appropriate operating conditions in the gas phase reactor, by selecting a start-up policy favouring the initial particle growth rate of the individual polymer particles so as to reduce the population of the small-size polymer particles during the initial stages of the gas-phase reaction, is a key aspect towards good catalyst performance and, consequently, smooth GPR operability and reactor performance that in turn would establish the right polymerisation conditions to produce the desired product targets.

The present process thus allows the utilization of single-site catalysts that are capable of incorporating high amount of comonomer (high comonomer sensitive catalyst) while achieving smooth catalyst performance without experiencing process limitations due to sheeting, chunking, and reactor fouling mainly caused by the presence of small-size polymer particles (fines).

### Process

The present disclosure relates to a multistage polymerisation process using a polymerisation catalyst, said process comprising an optional but preferred prepolymerisation step, followed by a first and a second polymerisation step.

Preferably, the same polymerisation catalyst is used in each step and ideally, it is transferred from prepolymerisation to subsequent polymerisation steps in sequence in a well-known manner. One preferred process configuration is based on a Borstar® type cascade, in particular Borstar® 2G type cascade, preferably Borstar® 3G type cascade.

Accordingly, the present process for polymerising olefins in multi stage polymerisation process configuration, comprises
a) polymerising in a first polymerisation step ethylene, optionally in the presence of at least one other alpha olefin comonomer, in the presence of a polymerisation catalyst so as to form a first polymer component (A); and
b) polymerising in a second polymerisation step in gas phase a predetermined monomer mixture comprising ethylene and 1-hexene, optionally in the presence of at least one other alpha olefin comonomer, in the presence of the first polymer component (A) of step a), so as to form a second polymer component (B),
wherein the multimodal polyethylene polymer produced by the present process comprises 1-hexene comonomer and at least one further C4-10-comonomer.

### Prepolymerisation Step

Polymerisation steps may be preceded by a prepolymerisation step. The purpose of the prepolymerisation is to polymerise a small amount of polymer onto the catalyst at a low temperature and/or a low monomer concentration. By prepolymerisation it is possible to improve the performance of the catalyst in slurry and/or modify the properties of the final polymer. The prepolymerisation step is preferably conducted in slurry and the amount of polymer produced in an optional prepolymerisation step is counted to the amount (wt %) of ethylene polymer component (A).

The catalyst components are preferably all introduced to the prepolymerisation step when a prepolymerisation step is present. Preferably the reaction product of the prepolymerisation step is then introduced to the first polymerisation step.

However, where the solid catalyst component and the cocatalyst can be fed separately it is possible that only a part of the cocatalyst is introduced into the prepolymerisation stage and the remaining part into subsequent polymerisation stages. Also in such cases, it is necessary to introduce so much cocatalyst into the prepolymerisation stage that a sufficient polymerisation reaction is obtained therein.

It is understood within the scope of the invention, that the amount or polymer produced in the prepolymerisation lies within 1 to 7 wt % in respect to the final multimodal (co)polymer. This can counted as part of the first polymer component (A) produced in the first polymerisation step a).

### First Polymerisation Step a)

In the present process the first polymerisation step a) involves polymerising ethylene monomer and optionally at least one olefin comonomer.

In one embodiment the first polymerisation step involves polymerising ethylene to produce ethylene homopolymer.

In another embodiment the first polymerisation step involves polymerising ethylene and at least one olefin comonomer to produce ethylene copolymer.

The first polymerisation step may take place in any suitable reactor or series of reactors. The first polymerisation step may take place in one or more slurry polymerisation reactor(s). Preferably the first polymerisation step takes place in one or more slurry polymerisation reactor(s), more preferably in at least three slurry-phase reactors including a slurry-phase reactor for carrying out prepolymerisation.

The polymerisation in the first polymerisation zone is preferably conducted in slurry. Then the polymer particles formed in the polymerisation, together with the catalyst fragmented and dispersed within the particles, are suspended in the fluid hydrocarbon. The slurry is agitated to enable the transfer of reactants from the fluid into the particles.

The slurry polymerisation usually takes place in an inert diluent, typically a hydrocarbon diluent such as methane, ethane, propane, n-butane, isobutane, pentanes, hexanes, heptanes, octanes etc., or their mixtures. Preferably the diluent is a low-boiling hydrocarbon having from 1 to 4 carbon atoms or a mixture of such hydrocarbons. An especially preferred diluent is propane, possibly containing minor amount of methane, ethane and/or butane.

The ethylene content in the fluid phase of the slurry may be from 2 to about 50 mol % by, preferably from about 3 to about 20 mol % and in particular from about 5 to about 15 mol %. The benefit of having a high ethylene concentration is that the productivity of the catalyst is increased but the drawback is that more ethylene then needs to be recycled than if the concentration was lower.

The temperature in the slurry polymerisation is typically from 50 to 115° C., preferably from 60 to 110° C. and in particular from 70 to 100° C. The pressure is from 1 to 150 bar, preferably from 10 to 100 bar.

The pressure in the first polymerisation step is typically from 35 to 80 bar, preferably from 40 to 75 bar and in particular from 45 to 70 bar.

The residence time in the first polymerisation step is typically from 0.15 h to 3.0 h, preferably from 0.20 h to 2.0 h and in particular from 0.30 to 1.5 h.

It is sometimes advantageous to conduct the slurry polymerisation above the critical temperature and pressure of the fluid mixture. Such operation is described in U.S. Pat. No. 5,391,654. In such operation, the temperature is typically from 85 to 110° C., preferably from 90 to 105° C. and the pressure is from 40 to 150 bar, preferably from 50 to 100 bar.

The slurry polymerisation may be conducted in any known reactor used for slurry polymerisation. Such reactors include a continuous stirred tank reactor and a loop reactor. It is especially preferred to conduct the polymerisation in loop reactor. In loop reactors the slurry is circulated with a high velocity along a closed pipe by using a circulation pump. Loop reactors are generally known in the art and examples are given, for instance, in U.S. Pat. Nos. 4,582,816, 3,405,109, 3,324,093, EP-A-479186 and U.S. Pat. No. 5,391,654.

The slurry may be withdrawn from the reactor either continuously or intermittently. A preferred way of intermittent withdrawal is the use of settling legs where slurry is allowed to concentrate before withdrawing a batch of the concentrated slurry from the reactor. The use of settling legs is disclosed, among others, in U.S. Pat. Nos. 3,374,211, 3,242,150 and EP-A-1310295. Continuous withdrawal is disclosed, among others, in EP-A-891990, EP-A-1415999, EP-A-1591460 and WO-A-2007/025640. The continuous withdrawal is advantageously combined with a suitable concentration method, as disclosed in EP-A-1310295, EP-A-1591460, and EP3178853B1.

A cyclone may be placed at the exit of the disengagement zone (recirculation gas pipe) to collect the entrained particles (estimate the particles carry over) as well as to prevent small size particles going through the gas compressor and heat exchanger.

Hydrogen may be fed into the reactor to control the molecular weight of the polymer as known in the art. Furthermore, one or more alpha-olefin comonomers may be added into the reactor to control the density of the polymer product. The actual amount of such hydrogen and comonomer feeds depends on the catalyst that is used and the desired melt index (or molecular weight) and density (or comonomer content) of the resulting polymer.

### Second Polymerisation Step b)

From the first polymerisation step the first polymer component (A) is transferred to the second polymerisation step.

In the present process the second polymerisation step b) involves polymerising ethylene monomer and 1-hexene comonomer and optionally at least one other alpha olefin comonomer.

In one embodiment the second polymerisation step involves polymerising ethylene and 1-hexene and at least one olefin comonomer to produce ethylene terpolymer.

In another embodiment the second polymerisation step involves polymerising ethylene and 1-hexene and 1-butene to produce ethylene/1-butene/1-hexene terpolymer.

The second polymerisation step takes place in one or more gas phase polymerisation reactor(s).

The gas phase polymerisation may be conducted in any known reactor used for gas phase polymerisation. Such reactors include a fluidized bed reactor, a fast fluidized bed reactor or a settled bed reactor or in any combination of these. When a combination of reactors is used then the polymer is transferred from one polymerisation reactor to another. Furthermore, a part or whole of the polymer from a polymerisation stage may be returned into a prior polymerisation stage.

The gas phase polymerisation is typically conducted in gas-solids fluidized beds, also known as gas phase reactors (GPR). Gas solids olefin polymerisation reactors are commonly used for the polymerisation of alpha-olefins such as ethylene and propylene as they allow relative high flexibility in polymer design and the use of various catalyst systems. A common gas solids olefin polymerisation reactor variant is the fluidized bed reactor.

A gas solids olefin polymerisation reactor is a polymerisation reactor for heterophasic polymerisation of gaseous olefin monomer(s) into polyolefin powder particles, which comprises three zones: in the bottom zone the fluidization gas is introduced into the reactor; in the middle zone, which usually has a generally cylindrical shape, the olefin monomer(s) present in the fluidization gas are polymerised to form the polymer particles; in the top zone the fluidization gas is withdrawn from the reactor. In certain types of gas solids olefin polymerisation reactors a fluidization grid (also named distribution plate) separates the bottom zone from the middle zone. In certain types of gas solids olefin polymerisation reactors the top zone forms a disengaging or entrainment zone in which due to its expanding diameter compared to the middle zone the fluidization gas expands and the gas disengages from the polyolefin powder.

The dense phase denotes the area within the middle zone of the gas solids olefin polymerisation reactor with an increased bulk density due to the formation of the polymer particles. In certain types of gas solids olefin polymerisation reactors, namely fluidized bed reactors, the dense phase is formed by the fluidized bed.

The temperature in the gas phase polymerisation is typically from 40 to 120° C., preferably from 50 to 100° C., more preferably from 65 to 90° C.

The pressure in the gas phase polymerisation is typically from 5 to 40 bar, preferably from 10 to 35 bar, preferably from 15 to 30 bar.

The residence time in the gas phase polymerisation is typically from 1.0 h to 4.5 h, preferably from 1.5 h to 4.0 h and in particular from 2.0 to 3.5 h.

The molar ratios of the reactants may be adjusted as follows: C6/C2 ratio of 0.0001-0.1 mol/mol, H2/C2 ratio of 0-0.1 mol/mol.

The polymer production rate in the gas phase reactor may be from 10 tn/h to 65 tn/h, preferably from 12 tn/h to 58 tn/h and in particular from 13 tn/h to 52.0 tn/h, and thus the total polymer withdrawal rate from the gas phase reactor may be from 15 tn/h to 100 tn/h, preferably from 18 tn/h to 90 tn/h and in particular from 20 tn/h to 80.0 tn/h.

The production split (% second polymer component (B)/% first polymer component (A)) may be from 0.65 to 2.5, preferably from 0.8 to 2.3, most preferably from 1.0 to 1.65.

The present process requires that 1-hexene is introduced to the second polymerisation step b) i.e. to the first gas phase reactor since the beginning of the gas phase reaction start up.

This can be achieved by introducing a predetermined monomer mixture of ethylene and 1-hexene to the second polymerisation step.

The molar ratio of 1-hexene to ethylene in the second polymerisation step is typically in the range from 7 mol/kmol to 80 mol/kmol, preferably from 8.0 mol/kmol to 60.0 mol/kmol and in particular from 9.0 to 50.0 mol/kmol.

The feed ratio of the predetermined 1-hexene/ethylene mixture is from 70 kg/t to 400 kg/t, preferably from 75 kg/t to 350 kg/t, more preferably 80 kg/t to 280 kg/t.

1-hexene may be introduced into the reaction vessel e.g. by via the comonomer fresh injection line that is placed at the downstream of the cooler and it is mixed with the recirculation gas stream that in turn is introduced into the gas phase reactor. Thus 1-hexene is preferably introduced simultaneously with ethylene, in particular not as a separate mixture of 1-hexene and ethylene.

The particle growth rate of individual polymer particles is proportional to the polymerisation rate (i.e. catalyst activity) and reverse proportional to the size of the particles and the density of the particles polymer phase. Thus, the presence of 1-hexene since the beginning of the GPR operation (GPR start up) results in the following positive effects regarding particle growth: i) it increases the solubility of smaller penetrants (i.e., ethylene) in the gas phase reactor due to the co-solubility effect (i.e., the high molecular weight olefin acts as solvent to the low molecular weight olefin), thus increasing the local polymerisation rate, ii) it decreases the particles' polymer phase density due to swelling effect, iii) it decreases the overall polymer density due to decreasing of crystallinity, therefore, the amorphous fraction of the polymer phase in the polymer particles is higher compared to the case of not having comonomer in the reactor leading to further increase of the sorbed amount of the reactants that in turn increase the local polymerisation rate and thus the particle growth rate and iv) it provides the needed time for the sorption process of 1-hexene in the polymer particles which leads to homogeneous distribution of 1-hexene sorbed concentration in the polymer particles (increased reactants homogeneity at particle level).

### Polymerisation Catalyst

The polymerisation catalyst utilized in the present process is a metallocene catalyst. The polymerisation catalyst typically comprises (i) a transition metal complex, (ii) a cocatalyst, and optionally (iii) a support.

Preferably the first and the second polymerisation step are performed using, i.e. in the presence of, the same metallocene catalyst.

The present process preferably utilizes single-site catalysis. Polyethylene copolymers made using single-site catalysis, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

### Transition Metal Complex (i)

The transition metal complex comprises a transition metal (M) of Group 3 to 10 of the Periodic Table (IUPAC 2007) or of an actinide or lanthanide.

The term “transition metal complex” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment, the transition metal complex has the following formula (i-I):

(L)ₘRₙMX_{q} (i-I)
wherein
“M” is a transition metal (M) of Group 3 to 10 of the Periodic Table (IUPAC 2007),
each “X” is independently a monoanionic ligand, such as a σ-ligand,
each “L” is independently an organic ligand which coordinates to the transition metal “M”,
“R” is a bridging group linking said organic ligands (L),
“m” is 1, 2 or 3, preferably 2
“n” is 0, 1 or 2, preferably 0 or 1,
“q” is 1, 2 or 3, preferably 2 and
m+q is equal to the valence of the transition metal (M).
“M” is preferably selected from the group consisting of zirconium (Zr), hafnium (Hf), or titanium (Ti), more preferably selected from the group consisting of zirconium (Zr) and hafnium (Hf). “X” is preferably a halogen, most preferably Cl.

Most preferably, the transition metal complex (i) is a metallocene complex, which comprises a transition metal compound, as defined above, which contains a cyclopentadienyl, indenyl or fluorenyl ligand as the substituent “L”. Further, the ligands “L” may have one or more substituents, such as alkyl groups, aryl groups, arylalkyl groups, alkylaryl groups, silyl groups, siloxy groups, alkoxy groups or other heteroatom groups or the like. Suitable metallocene catalysts are known in the art and are disclosed, among others, in WO-A-95/12622, WO-A-96/32423, WO-A-97/28170, WO-A-98/32776, WO-A-99/61489, WO-A-03/010208, WO-A-03/051934, WO-A-03/051514, WO-A-2004/085499, EP-A-1752462 and EP-A-1739103.

In an embodiment of the invention the metallocene complex is bis(1-methyl-3-n-butylcyclopentadienyl) zirconium (IV) chloride.

In another embodiment, the transition metal complex (i) has the following formula (i-II):

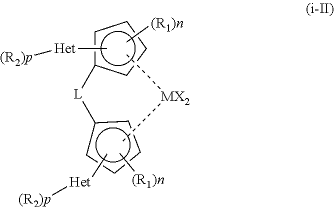

wherein each X is independently a halogen atom, a C1-6-alkyl, C1-6-alkoxy group, phenyl or benzyl group;
each Het is independently a monocyclic heteroaromatic containing at least one heteroatom selected from O or S;
L is-R′2Si—, wherein each R′ is independently C1-20 hydrocarbyl or C1-10 alkyl substituted with alkoxy having 1 to 10 carbon atoms;
M is Ti, Zr or Hf;
each R₁ is the same or different and is a C1-6 alkyl group or C1-6 alkoxy group;
each n is 1 to 2;
each R₂ is the same or different and is a C1-6 alkyl group, C1-6 alkoxy group or —Si(R)3 group;
each R is C1-10 alkyl or phenyl group optionally substituted by 1 to 3 C1-6 alkyl groups; and
each p is 0 to 1.

Preferably, the compound of formula (i-II) has the structure (i-III)

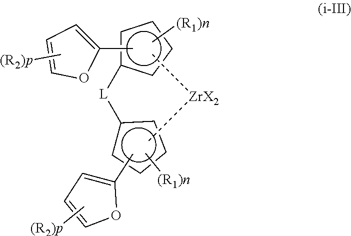

wherein each X is independently a halogen atom, a C1-6-alkyl, C1-6-alkoxy group, phenyl or benzyl group;
L is a Me2Si—;
each R₁ is the same or different and is a C1-6 alkyl group, e.g. methyl or t-Bu;
each n is 1 to 2;
R₂ is a —Si(R)3 alkyl group; each p is 1;
each R is C1-6 alkyl or phenyl group.

Highly preferred transition metal complexes of formula (i-III) are

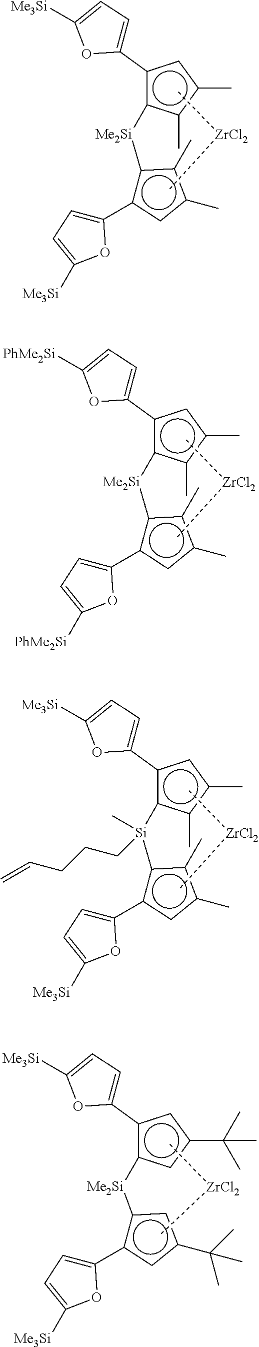

### Cocatalyst (ii)

To form a polymerisation catalyst, a cocatalyst, also known as an activator, is used, as is well known in the art. Cocatalysts comprising Al or B are well known and can be used here. The use of aluminoxanes (e.g. MAO) or boron based cocatalysts (such as borates) is preferred.

Suitable cocatalysts are metal alkyl compounds and especially aluminium alkyl compounds known in the art. Especially suitable activators used with metallocene catalysts are alkylaluminium oxy-compounds, such as methylalumoxane (MAO), tetraisobutylalumoxane (TIBAO) or hexaisobutylalumoxane (HIBAO).

Preferably the cocatalyst is methylalumoxane (MAO).

Support (iii)

It is possible to use the present polymerisation catalyst in solid but unsupported form following the protocols in WO03/051934. The present polymerisation catalyst is preferably used in solid supported form. The particulate support material used may be an inorganic porous support such as a silica, alumina or a mixed oxide such as silica-alumina, in particular silica.

The use of a silica support is preferred.

Especially preferably, the support is a porous material so that the complex may be loaded into the pores of the particulate support, e.g. using a process analogous to those described in WO94/14856, WO95/12622, WO2006/097497 and EP1828266.

The average particle size of the support such as silica support can be typically from 10 to 100 μm. The average particle size (i.e. median particle size, D₅₀) may be determined using the laser diffraction particle size analyser Malvern Mastersizer 3000, sample dispersion: dry powder.

The average pore size of the support such as silica support can be in the range 10 to 100 nm and the pore volume from 1 to 3 mL/g.

Examples of suitable support materials are, for instance, ES757 produced and marketed by PQ Corporation, Sylopol 948 produced and marketed by Grace or SUNSPERA DM-L-303 silica produced by AGC Si-Tech Co. Supports can be optionally calcined prior to the use in catalyst preparation in order to reach optimal silanol group content.

The catalyst can contain from 5 to 500 μmol, such as 10 to 100 μmol of transition metal per gram of support such as silica, and 3 to 15 mmol of Al per gram of support such as silica.

### Multimodal Polyethylene Polymer

The present invention concerns the preparation of a multimodal polyethylene copolymer. The density of the multimodal ethylene copolymer may be between 900 and 980 kg/m³, preferably 905 to 940 kg/m³, especially 910 to 935 kg/m³.

It is preferred if the multimodal polyethylene polymer is a copolymer. More preferably, the multimodal polyethylene copolymer is an LLDPE. It may have a density of 905 to 940 kg/m³, preferably 910 to 935 kg/m³, more preferably 915 to 930 kg/m³, especially of 916 to 928 kg/m³. In one embodiment a range of 910 to 928 kg/m³ is preferred. The term LLDPE used herein refers to linear low density polyethylene. The LLDPE is preferably multimodal.

The term “multimodal” includes polymers that are multimodal with respect to MFR and includes also therefore bimodal polymers. The term “multimodal” may also mean multimodality with respect to the “comonomer distribution”.

Usually, a polymer comprising at least two polyethylene fractions, which have been produced under different polymerisation conditions resulting in different (weight average) molecular weights and molecular weight distributions for the fractions, is referred to as “multimodal”. The prefix “multi” relates to the number of different polymer fractions present in the polymer. Thus, for example, the term multimodal polymer includes so called “bimodal” polymers consisting of two fractions. The form of the molecular weight distribution curve, i.e. the appearance of the graph of the polymer weight fraction as a function of its molecular weight, of a multimodal polymer, e.g. LLDPE, may show two or more maxima or at least be distinctly broadened in comparison with the curves for the individual fractions. Often the final MWD curve will be broad, skewered or displaying a shoulder.

Ideally, the molecular weight distribution curve for multimodal polymers of the invention will show two distinct maxima. Alternatively, the polymer fractions have similar MFR and are bimodal in the comonomer content. A polymer comprising at least two polyethylene fractions, which have been produced under different polymerisation conditions resulting in different comonomer content for the fractions, is also referred to as “multimodal”.

For example, if a polymer is produced in a sequential multi-stage process, utilising reactors coupled in series and using different conditions in each reactor, the polymer fractions produced in the different reactors will each have their own molecular weight distribution and weight average molecular weight. When the molecular weight distribution curve of such a polymer is recorded, the individual curves from these fractions are superimposed into the molecular weight distribution curve for the total resulting polymer product, usually yielding a curve with two or more distinct maxima.

In any multimodal polymer, there may be a lower molecular weight component (LMW) and a higher molecular weight component (HMW). The LMW component has a lower molecular weight than the higher molecular weight component. This difference is preferably at least 5000 g/mol.

The multimodal polyethylene polymer produced by the present process comprises 1-hexene comonomer and at least one further C4-10-comonomer. 1-hexene comonomer is present in the second polymer component (B). Further comonomers may be present in the HMW component (or second component (B), produced in the second polymerisation step) or the LMW component (or first component (A), produced in the first polymerisation step) or both. From here on, the term LMW/HMW component will be used but the described embodiments apply to the first and second components respectively.

It is preferred that the HMW component comprises at least one C4-10-comonomer. The LMW component may then be an ethylene homopolymer or may also comprise at least one C4-10-comonomer. In a preferred embodiment, the multimodal polyethylene polymer comprises at least two, e.g. exactly two, C4-10 comonomers.

In one embodiment, the multimodal polyethylene polymer is a terpolymer and comprises hexene-comonomer and at least one C4-10-comonomers. In that scenario, the HMW component may be a terpolymer component and the lower molecular weight (LMW) component can be an ethylene homopolymer component or copolymer component. Alternatively, both LMW and HMW components can be copolymers such that at least two C4-10-comonomers are present.

The multimodal polyethylene polymer may therefore be one in which the HMW component comprises repeat units deriving from ethylene and at least two other C4-10 alpha olefin monomers such as 1-butene and one C6-10 alpha olefin monomer. Ethylene preferably forms the majority of the LMW or HMW component. In the most preferred embodiment, the LMW component may comprise an ethylene 1-butene copolymer and the HMW component may comprise an ethylene 1-hexene copolymer.

The overall comonomer content in the multimodal polyethylene polymer may be for example 0.2 to 14.0% by mol, preferably 0.3 to 12% by mol, more preferably 0.5 to 10.0% by mol and most preferably 0.6 to 8.5% by mol.

1-Butene may be present in an amount of 0.05 to 6.0% by mol, such as 0.1 to 5% by mol, more preferably 0.15 to 4.5% by mol and most preferably 0.2 to 4% by mol.

The C6 to C10 alpha olefin may be present in an amount of 0.2 to 6% by mol, preferably 0.3 to 5.5% by mol, more preferably 0.4 to 4.5% by mol.

Preferably, the LMW component has lower amount (mol %) of comonomer than the HMW component, e.g. the amount of comonomer, preferably of 1-butene in the LMW component is from 0.05 to 0.9 mol %, more preferably from 0.1 to 0.8 mol %, whereas the amount of comonomer, preferably of 1-hexene in the HMW component (B) is from 1.0 to 8.0 mol %, more preferably from 1.2 to 7.5 mol %.

The multimodal polyethylene copolymer may therefore be formed from ethylene along with at least one of 1-butene, 1-hexene or 1-octene. The multimodal polyethylene polymer may be an ethylene butene hexene terpolymer, e.g. wherein the HMW component is an ethylene butene hexene terpolymer and the LMW is an ethylene homopolymer component. The use of a terpolymer of terpolymer of ethylene with 1-octene and 1-hexene comonomers is also envisaged.

In a further embodiment, the multimodal polyethylene copolymer may comprise two ethylene copolymers, e.g. such as two ethylene butene copolymers or an ethylene butene copolymer (e.g. as the LMW component) and an ethylene hexene copolymer (e.g. as the HMW component). It would also be possible to combine an ethylene copolymer component and an ethylene terpolymer component, e.g. an ethylene butene copolymer (e.g. as the LMW component) and an ethylene butene hexene terpolymer (e.g. as the HMW component).

The LMW component of the multimodal polyethylene polymer may have a MFR2 of 0.5 to 3000 g/10 min, more preferably 1.0 to 1000 g/10 min. In some embodiments, the MFR2 of the LMW component may be 50 to 3000 g/10 min, more preferably 100 to 1000 g/10 min, e.g. where the target is a cast film.

The molecular weight (Mw) of the LMW component should preferably range from 20,000 to 180,000, e.g. 40,000 to 160,000. It may have a density of at least 925 kg/m3, e.g. at least 940 kg/m³. A density in the range of 930 to 950 kg/m³, preferably of 935 to 945 kg/m³ is possible.

The HMW component of the multimodal polyethylene polymer may, for example, have an MFR2 of less than 1 g/10 min, such as 0.2 to 0.9 g/10 min, preferably of 0.3 to 0.8 and more preferably of 0.4 to 0.7 g/10 min. It may have a density of less than 915 kg/m³, e.g. less than 910 kg/m³, preferably less than 905 kg/m³. The Mw of the higher molecular weight component may range from 70,000 to 1,000,000, preferably 100,000 to 500,000.

The LMW component may form 30 to 70 wt % of the multimodal polyethylene polymer such as 35 to 65 wt %, especially 38 to 62 wt %.

The HMW component may form 30 to 70 wt % of the multimodal polyethylene polymer such as 35 to 65 wt %, especially 38 to 62 wt %.

In one embodiment, there is 40 to 45 wt % of the LMW component and 60 to 55 wt % of the HMW component.

In one embodiment, the polyethylene polymer consists of the HMW and LMW components as the sole polymer components.

The multimodal polyethylene polymer of the invention may have a MFR2 of 0.01 to 50 g/10 min, preferably 0.05 to 25 g/10 min, especially 0.1 to 10 g/10 min.

The molecular weight distribution (MWD, Mw/Mn) of a polyethylene terpolymer of the invention is in a range of 2.0 to 15.0, preferably in a range of 2.2 to 10.0 and more preferably in a range of 2.4 to 4.6.

### EXAMPLES

### Polymer Analytics and Characterisation

### Bulk Density

Bulk density of the polymer powder can be determined according to standard methods such as ISO 60:1977 or ASTM D1895-17.

### MFR

The melt flow rate (MFR) is determined according to ISO 1133 and is indicated in g/10 min. The MFR is an indication of the flowability, and hence the processability, of the polymer. The higher the melt flow rate, the lower the viscosity of the polymer. The MFR2 of polypropylene is determined at a temperature of 230° C. and a load of 2.16 kg, the MFR5 of polyethylene is measured at a temperature 190° C. and a load of 5 kg and the MFR2 of polyethylene at a temperature 190° C. and a load of 2.16 kg.

### Density

Density of polymers is measured according to ISO 1183-2/1872-2B.

### GPC

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ISO 16014-1:2003, ISO 16014-2:2003, ISO 16014-4:2003 and ASTM D 6474-12 using the following formulas:

$${M}_{n} = \frac{{\sum }_{i = 1}^{N} {A}_{i}}{{\sum }_{i = 1}^{N} ( {A}_{i} / {M}_{i} )} \qquad ( 1 )$$

$${M}_{w} = \frac{{\sum }_{i = 1}^{N} ( {A}_{i} \times {M}_{i} )}{{\sum }_{i = 1}^{N} {A}_{i}} \qquad ( 2 )$$

$${M}_{Z} = \frac{{\sum }_{i = 1}^{N} ( {A}_{i} \times {M}_{i}^{2} )}{{\sum }_{i = 1}^{N} ( {A}_{i} \times {M}_{i} )} \qquad ( 3 )$$

For a constant elution volume interval ΔVᵢ, where Aᵢ, and Mᵢ are the chromatographic peak slice area and polyolefin molecular weight (MW), respectively associated with the elution volume, Vᵢ, where N is equal to the number of data points obtained from the chromatogram between the integration limits.

A high temperature GPC instrument, equipped with either infrared (IR) detector (IR4 or IR5 from PolymerChar (Valencia, Spain), equipped with 3× Agilent-PLgel Olexis and 1× Agilent-PLgel Olexis Guard columns was used. As the solvent and mobile phase 1,2,4-trichlorobenzene (TCB) stabilized with 250 mg/L 2,6-Di tert butyl-4-methyl-phenol) was used. The chromatographic system was operated at 160° C. and at a constant flow rate of 1 mL/min. 200 μL of sample solution was injected per analysis. Data collection was performed using either Agilent Cirrus software version 3.3 or PolymerChar GPC-IR control software.

The column set was calibrated using universal calibration (according to ISO 16014-2:2003) with 19 narrow MWD polystyrene (PS) standards in the range of 0.5 kg/mol to 11 500 kg/mol. The PS standards were dissolved at room temperature over several hours. The conversion of the polystyrene peak molecular weight to polyolefin molecular weights is accomplished by using the Mark Houwink equation and the following Mark Houwink constants:

| | |
|---|---|
| K_{PS} = 19 × 10⁻³ mL/g, | α_{PS} = 0.655 |
| K_{PE} = 39 × 10⁻³ mL/g, | α_{PE} = 0.725 |
| K_{PP} = 19 × 10⁻³ mL/g, | α_{PP} = 0.725 |

A third order polynomial fit was used to fit the calibration data.

All samples were prepared in the concentration range of 0.5-1 mg/ml and dissolved at 160° C. for 2.5 hours for PP or 3 hours for PE under continuous gentle shaking.

### Catalyst

### Loading of SiO₂:

10 kg of silica (PQ Corporation ES757, calcined 600° C.) was added from a feeding drum and inertized in the reactor until O₂ level below 2 ppm was reached.

### Preparation of MAO/tol/MC:

30 wt % MAO in toluene (14.1 kg) was added into another reactor from a balance followed by toluene (4.0 kg) at 25° C. (oil circulation temp) and stirring 95 rpm. Stirring speed was increased 95 rpm->200 rpm after toluene addition, stirring time 30 min. Metallocene Rac-dimethylsilanediylbis{2-(5-(trimethylsilyl)furan-2-yl)-4,5-dimethylcyclopentadien-1-yl}zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst:

Reactor temperature was set to 10° C. (oil circulation temp) and stirring 40 rpm for MAO/tol/MC addition. MAO/tol/MC solution (target 22.5 kg, actual 22.2 kg) was added within 205 min followed by 60 min stirring time (oil circulation temp was set to 25° C.). After stirring “dry mixture” was stabilised for 12 h at 25° C. (oil circulation temp), stirring 0 rpm. Reactor was turned 20° (back and forth) and stirring was turned on 5 rpm for few rounds once an hour.

After stabilisation the catalyst was dried at 60° C. (oil circulation temp) for 2 h under nitrogen flow 2 kg/h, followed by 13 h under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

### Example 1 (Comparative)

A single-site catalyst, having an initial size of 25 microns, span (i.e., (d90−d10)/d50) of 1.6 was employed to produce LLDPE film (target MFR2=1.3, target density=912-920 kg/m3). The catalyst was first prepolymerised in a prepolymerisation reactor at T=50° C. and P=56 barg. More specifically, 40.7 g/h catalyst, 4 kg/h of ethylene, 85 g/h of 1-butene, 0.03 g/h hydrogen and 46 kg/h propane (diluent) were fed into the prepoly reactor and the mean residence time was 23 mins. The production split was 3.0 wt %.

The product was transferred to a split loop reactor configuration, where in the first loop reactor, ethylene (C2), propane (C3), 1-butene (C4) and hydrogen (H2) were fed to the reactors at polymerisation conditions of T=85° C., P=54 barg and the mean residence time was equal to 0.31 h. The C2 concentration in the liquid phase was 3.9 mol %, the molar ratios of H2/C2 and C4/C2 were 0.38 mol/kmol and 35 mol/kmol, respectively. The production split in the first loop reactor of the split loop configuration was 18.5 wt % and the material produced had MFR2 (g/10 min)=4.7 and density=940.7 kg/m³.

Subsequently the product was transferred to the second loop reactor of the split loop reactor configuration, where the polymerisation conditions have been T=85° C., P=52 barg and the mean residence time was equal to 0.60 h. The C2 concentration in the liquid phase was 4.3 mol %, the molar ratios of H2/C2 and C4/C2 were 0.76 mol/kmol and 29 mol/kmol, respectively. The production split in the second loop reactor of the split loop configuration was 21.6 wt %, the material collected after the second loop reactor had MFR2 (g/10 min)=5.8 and density=940.2 kg/m3 and the overall catalyst productivity in the loop reactor configuration process was 1.0 kgPE/gcat.

Then, the material flashed out in a high-pressure separator, and subsequently, the polymer particles were transferred to the gas-phase reactor (GPR) that has operated at overall pressure of 19 barg and temperature of 75° C. The components' feed rates at steady state conditions were 0.007 kg/h H2, 103.9 kg/h C2, 3.37 kg/h C6 resulting in H2/C2=0.78 mol/kmol and C6/C2=4.18 mol/kmol, respectively. The overall residence time in the GPR has been 2.8 hours, the superficial gas velocity has been selected to be 0.32 m/s. The production split in the GPR was 56.9 wt %, the final pellet material collected after the GPR had MFR2 (g/10 min)=1.1 and density=932.1 kg/m³ and the overall catalyst productivity including loops and GPR reactors configuration process was 2.3 kgPE/gcat.

In the above example, the C6 was fed in GPR after several hours of GPR start up.

Two and a half days after feeding the 1-hexene, severe operability issues related to sheeting and chunking were experienced resulting in GPR shut down. Just before the GPR shut down, GPR spot sample had MFR2 of 0.55 g/10 min and density 926.8 kg/m3 at GPR split of 58.7 wt %. The highest C6/C2 feed rate ratio to GPR was only 47.5 kg/t.

### Example 2 and 3 (Inventive)

The procedure of CE1 was repeated with the exception that the C6 has been fed in to the GPR during start up.

In this case, no operability issues, smooth operation and good performance of the GPR observed for about 10 days, thus producing the targeted material properties as described in IE1 and IE2. The highest C6/C2 feed rate ratio to GPR was 162.8 kg/t.

TABLE 1

| | CE1 | IE1 | IE2 |
|---|---|---|---|
| Prepoly reactor | | | |
| Catalyst feed (g/h) | 40.7 | 30.7 | 35 |
| Temp. (° C.) | 50 | 50 | 50 |
| Press. (kPa) | 5690 | 5642 | 5639 |
| C2 (kg/h) | 4 | 4 | 4 |
| H2 (g/h) | 0.03 | 0 | 0.04 |
| C4 (g/h) | 85 | 79.6 | 81.9 |
| Split (%) | 3.0 | 3.5 | 3.4 |
| A21 loop reactor | | | |
| Temp. (° C.) | 85 | 85 | 85 |
| Press. (kPa) | 5523 | 5540 | 5544 |
| C2 conc. (mol-%) | 3.9 | 3.9 | 3.5 |
| H2/C2 ratio (mol/kmol) | 0.38 | 0.4 | 0.41 |
| C4/C2 ratio (mol/kmol) | 35 | 47.2 | 41.3 |
| Split % | 18.5 | 17.7 | 17.6 |
| Density (kg/m3) | 940.7 | 939.3 | 941 |
| MFR2 (g/10 min) | 4.7 | 3.7 | 5 |
| A2 loop reactor | | | |
| Temp. (° C.) | 85 | 85 | 85 |
| Press. (kPa) | 5333 | 5330 | 5325 |
| C2 conc. (mol-%) | 4.3 | 3.8 | 3.5 |
| H2/C2 ratio (mol/kmol) | 0.76 | 0.5 | 0.6 |
| C4/C2 ratio (mol/kmol) | 29 | 31 | 29 |
| Total diluent feed (kg/h) | 169.6 | 156.4 | 156.4 |
| Catalyst productivity after A2 | 1.0 | 1.1 | 1.0 |
| Split (%) | 21.6 | 20.8 | 20.4 |
| Density (kg/m3) | 940.2 | 938.5 | 940.7 |
| MFR2 (g/10 min) | 5.8 | 4.3 | 5.8 |
| A3 GPR | | | |
| Temp. (° C.) | 75 | 75 | 75 |
| Press. (kPa) | 2000 | 2000 | 2000 |
| Bed level (cm) | 160 | 160 | 160 |
| C2 partial Press. (kPa) | 926 | 662 | 642 |
| C3 (mol %) | 15.5 | 24 | 24 |
| H2/C2 ratio (mol/kmol) | 0.78 | 1.2 | 1.18 |
| C6/C2 ratio (mol/kmol) | 4.18 | 10.02 | 14.5 |
| C6 (kg/h) | 3.37 | 8.01 | 11.41 |
| C2 (kg/h) | 103.9 | 80.4 | 74.25 |
| C6/C2 feed ratio (kg/t) | 32.4 | 99.6 | 153.7 |
| Residence time (h) | 2.8 | 3.1 | 3.1 |
| Split % | 56.9 | 58 | 58.6 |
| Bulk density (kg/m3) | | 457 | |
| Cat total productivity (kg PE/g cat) | 2.3 | 2.59 | 2.34 |
| Powder | | | |
| Density (kg/m3) | 931.9 | 919 | 912.6 |
| MFR2 (g/10 min) | 0.9 | 1.65 | 1.32 |
| MFR5 (g/10 min) | 2.59 | 4.77 | 3.94 |
| MFR21 (g/10 min) | 23.8 | 46.9 | 39.5 |
| Pellet | | | |
| MFR2 (g/10 min) | 1.1 | 1.61 | 1.31 |
| MFR5 (g/10 min) | 2.73 | 4.81 | 3.86 |
| MFR21 (g/10 min) | 23.9 | 44 | 38.7 |
| Density (kg/m3) | 932.1 | 919.6 | 912.7 |

1. A process for polymerising olefins in multi stage polymerisation process configuration, the process comprising
a) polymerising in a first polymerisation step ethylene, optionally in the presence of at least one other alpha olefin comonomer, in the presence of a polymerisation catalyst so as to form a first polymer component (A); and
b) polymerising in a second polymerisation step in gas phase a predetermined monomer mixture comprising ethylene and 1-hexene, optionally in the presence of at least one other alpha olefin comonomer, in the presence of the first polymer component (A) of step a), so as to form a second polymer component (B),
wherein the multimodal polyethylene polymer produced by the present process comprises 1-hexene comonomer and at least one further C4-10-comonomer, and
wherein the predetermined monomer mixture comprising ethylene and 1-hexene is fed into the second polymerisation step from the beginning of its start up.

2. The process according to claim 1, where the polymerisation catalyst is a single-site catalyst.

3. The process according to claim 1, where the polymerisation catalyst comprises (i) a transition metal complex, (ii) a cocatalyst, and optionally (iii) a support.

4. The process according to claim 1, wherein 1-hexene and ethylene in the second polymerisation step have a molar ratio in the range from 7 mol/kmol to 80 mol/kmol.

5. The process according to claim 1, wherein the gas phase polymerisation has a temperature of from 40 to 120° C.

6. The process according to claim 1, wherein the gas phase polymerisation has a pressure from 5 to 40 bar.

7. The process according to claim 1, wherein the gas phase polymerisation has a residence time from 1.0 h to 4.0 h.

8. A method of use of 1-hexene in a gas phase olefin polymerisation step for improving performance of single-site polymerisation catalyst in multi-stage olefin copolymerisation process.

9. The method of use as claimed in claim 8, wherein a predetermined monomer mixture comprising ethylene and 1-hexene is fed into the gas phase polymerisation step from the beginning of its start up.

10. The method of use as claimed in claim 9, wherein 1-hexene and ethylene in the gas phase olefin polymerisation step have a molar ratio in the range from 7 mol/kmol to 40 mol/kmol.

11. The method of use as claimed in claim 9, wherein the predetermined monomer mixture comprising ethylene and 1-hexene is fed into the gas phase polymerisation step at a feed ratio of from 70 kg/t to 400 kg/t.

12. A method for improving performance of single-site polymerisation catalyst in a multi-stage olefin polymerisation comprising feeding a predetermined monomer mixture comprising ethylene and 1-hexene into the gas phase polymerisation step from the beginning of its start up.

13. The method as claimed in claim 12, wherein 1-hexene and ethylene in the gas phase polymerisation step have a molar ratio in the range from 7 mol/kmol to 40 mol/kmol.

14. The method as claimed in claim 12, wherein the predetermined monomer mixture comprising ethylene and 1-hexene is fed into the gas phase polymerisation step at a feed ratio of from 70 kg/t to 400 kg/t.

15. The method as claimed in claim 12, wherein the single-site catalyst comprises (i) a transition metal complex, (ii) a cocatalyst, and optionally (iii) a support.
